(19) United States
(12) Patent Application Publication
(10) Pub. No.: US 2006/0046046 A1
(43) Pub. Date: Mar. 2, 2006

(54) Polymer film with three-dimensional nanopores and fabrication method thereof

(75) Inventors: Wu-Jing Wang, Hsinchu City (TW); Yen-Po Wang, Taipei City (TW); Joung-Yei Chen, Taipei County (TW)

Correspondence Address: BIRCH STEWART KOLASCH & BIRCH, PO BOX 747, FALLS CHURCH, VA, 22040-0747, US

(73) Assignee: INDUSTRIAL TECHNOLOGY RESEARCH INSTITUTE

(21) Appl. No.: 11/204,164

(22) Filed: Aug. 16, 2005

(30) Foreign Application Priority Data
Aug. 31, 2004 (TW) 93126156

(51) Int. Cl. B32B 3/00

(52) U.S. Cl. 428/315.7; 428/315.5; 428/317.9

(57) ABSTRACT

A polymer film with three-dimensional nanopores and fabrication method thereof. The polymer film according to the invention has a plurality of nanopores distributed uniformly thereover and presents a sponge-like profile. Due to the nanopores being sufficiently filled by air, the polymer film has a refractive index less than 1.45, reducing the reflectivity thereof to less than 2.0%. Furthermore, the polymer film exhibits superior antifouling properties as the contact angle of the polymer film to water greater than 90°.

### BACKGROUND

The present invention relates to a porous polymer film and fabrication method thereof, and more particularly to a polymer film with three-dimensional nanopores having a sponge-like profile and fabrication method thereof.

An antireflection film is generally disposed on an outermost surface of an image display device such as an optical lens, cathode ray tube display device (CRT), plasma display panel (PDP), liquid crystal display device (LCD), or organic electroluminescent device, to reduce reflectance thus preventing optical interference caused by external light.

Single-layer antireflection films possess the advantages of high yield, simple fabrication process, and low cost, making them the choice of the display industry. Antireflection film made of conventional organic compounds containing fluorine used in multi-layer antireflection films, such as CaF₂, or MgF₂, however, cannot achieve sufficiently high scratch resistance due to the poor cohesion of the fluorine-containing compound. Thus, a hard coat layer must be formed thereon. Furthermore, the antireflection film made thereby has a sufficient refractive index in the range from 520 to 570 nm, and the refractive index thereof cannot be further reduced to 1.40 or less.

U.S. Pat. No. 6,605,229 discloses a single-layer antireflection film with a wave-shaped profile. The method for fabricating the single-layer antireflection film with a wave-shaped profile comprises the following steps. First, two mutually incompatible polymers are dissolved in a solvent to prepare a solution with a common intermixed phase, and a substrate is coated with the solution to form a coating. Finally, one of the two mutually incompatible polymers is removed from the coating to form an antireflection film with a wave-shaped profile. Particularly, the two mutually incompatible polymers produce immediate phase separation to form the coating having essentially laterally alternating polymer phases when the solution is coated on the substrate. As a result, after removing one of the two mutually incompatible polymers from the coating, an antireflection film, having a plurality of vertical openings with differing depths, consisting of the remaining polymer is formed. FIG. 1 is a schematic view showing the profiles of the antireflection film. Due to the plurality of vertical openings with different depths, the antireflection film has a gradient of the refractive index, further obtaining a low reflectance.

Since the Rmax (maximum peak-to-valley height) of the antireflection film is as high as the thickness thereof due to the phase separation mechanism responsible for two mutually incompatible polymers, the antireflection film exhibits inferior antifouling properties.

Therefore, in order to meet the demands of the market, an antireflection film with low refractive index and high antifouling properties is desirable.

### SUMMARY

The invention provides a polymer film, and the polymer film has a plurality of three-dimensional nanopores distributed uniformly thereover and presents a sponge-like profile. Due to the nanopores being sufficiently filled by air, the polymer film has a refractive index less than 1.45. The polymer film can be fabricated by the following steps. A coating of a polymer composition is formed on a substrate, wherein the polymer composition comprises the following components as a uniform solution in a first organic solvent: a polymerizable resin, having a reactive functionality of more than 2.0, in an amount of 45 to 95 parts by weight; a template in an amount of 5 to 55 parts by weight; and an initiator in an amount of 1 to 10 parts by weight, based on 100 parts by weight of the polymerizable resin and the template. The coating is cured to form a dry film. A second organic solvent dissolves the template out of the dry film to leave a polymer film with three-dimensional nanopores thereover. The polymer film can be 50˜500 nm thick, preferably 50˜200 nm thick, and the diameter of the nanopores can be 20˜80 nm.

The polymer film with three-dimensional nanopores of the invention can serve as an antireflection film, due to its advantages of anti-reflection, anti-glare, and antifoul. The product is formed by the following steps. A coating of a polymer composition is formed on a substrate, wherein the polymer composition comprises the following components as a uniform solution in a first organic solvent: a polymerizable resin, having a reactive functionality of more than 2.0, in an amount of 45 to 95 parts by weight; a template in an amount of 5 to 55 parts by weight; and an initiator in an amount of 1 to 10 parts by weight, based on 100 parts by weight of the polymerizable resin and the template. The coating is cured to form a dry film. A second organic solvent dissolves the template out of the dry film to leave an antireflection film with three-dimensional nanopores thereover. The antireflection film exhibits a reflectivity of less than 2.0%, a transparency of more than 93% and a haze of 0.1˜35%. The antireflection film can be disposed on an outermost surface of an image display device such as an optical lens, a cathode ray tube display device (CRT), a plasma display panel (PDP), a liquid crystal display device (LCD), or an organic electroluminescent device, to reduce reflectance so as to prevent optical interference caused by external light.

A detailed description is given in the following with reference to the accompanying drawing.

### BRIEF DESCRIPTION OF THE DRAWINGS

The invention can be more fully understood by reading the subsequent detailed description in conjunction with the examples and references made to the accompanying drawings, wherein:

FIG. 1 is a schematic diagram of a conventional antireflection film with wave-shaped profile.

FIG. 2a is a cross section of the polymer film with three-dimensional nanopores according to an embodiment of the invention.

FIG. 2b is a close-up cross-section view of location B shown in FIG. 2a.

FIGS. 3˜6 are scanning electron microscope (SEM) photographs of the polymer film according to Examples 1˜4.

FIG. 7 is a SEM photograph of the polymer film according to Comparative Example 1.

FIGS. 8˜9 are SEM photographs of the polymer film according to Examples 5 and 6.

FIG. 10 is a SEM photograph of the polymer film according to Comparative Example 2.

FIG. 11 is a SEM photograph of the polymer film with three-dimensional nanopores according to Example 7.

FIG. 12 is a graph plotting reflectivity against wavelength of the polymer film with three-dimensional nanopores according to Example 7.

FIG. 13 is a graph plotting transparency against wavelength of the polymer film with three-dimensional nanopores according to Example 7.

FIG. 14 is an atomic force microscope (AFM) photograph of the polymer film with three-dimensional nanopores according to Example 7.

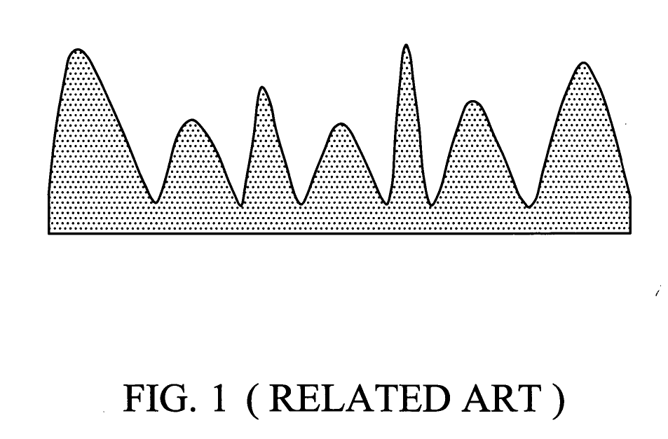

### DETAILED DESCRIPTION

The method for fabricating polymer film with three-dimensional nanopores, such as a nanoporous antireflection film, is described in detail in the following. First, a substrate with a surface is provided. The substrate can be a transparent substrate, such as a glass, plastic, or ceramic substrate. Next, a coating of a polymer composition is formed on the surface of the substrate. The polymer composition comprises a polymerizable resin, a template, and an initiator as a uniform solution in a first organic solvent. The polymerizable resin, template, and initiator are respectively in an amount of 45˜95 parts by weight, 5 to 55 parts by weight, and 1 to 10 parts by weight, based on 100 parts by weight of the polymerizable resin and the template.

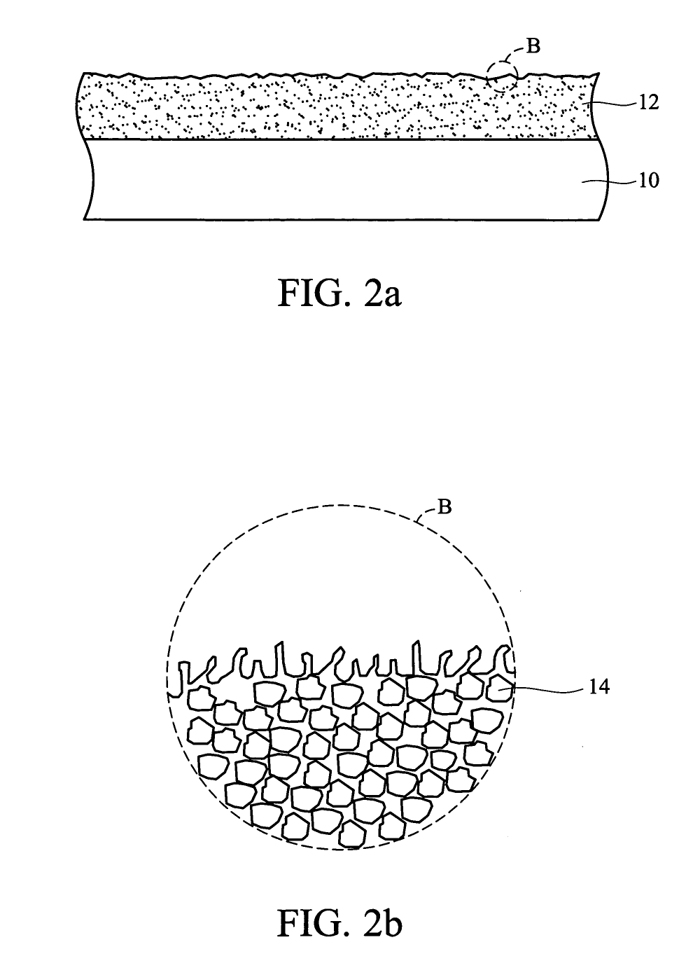

Next, the coating is cured to form a dry film, particles of the template disperse uniformly thereover, by heating or exposure to an actinic ray. Next, a second organic solvent dissolves the template out of the dry film, and a polymer film with three-dimensional nanopores thereover remains. Particularly, the polymer film presents a sponge-like profile, referring to FIGS. 2a and 2b. The polymer film 12 with three-dimensional nanopores 14 is formed on the substrate 10.

The polymer composition can be coated on the substrate by spin coating, dip coating, roll coating, printing, embossing, stamping, or spray coating. The polymerizable resin, employed in the present invention, has a reactive functionality of more than 2.0, preferably of more than 2.5, and can be acrylic resin, epoxy resin, polyurethane, or combinations thereof. In addition, the polymerizable resin can comprise acrylic resin with a reactive functionality of 3˜9, epoxy resin with a reactive functionality of 3˜9, or polyurethane with a reactive functionality of 3˜9, such as triethyleneglycol diacrylate, tripropyleneglycol diacrylate, neopentylglycol diacrylate, trimethylolpropane triacrylate, trimethylolpropane trimethacrylate, triacylate of ethylene oxide modified trimethylolpropane pentaerythritol triacrylate, pentaerythritol tetraacrylate, ethoxylated pentaerythritol tetraacrylate, dipentaerythritol pentaacrylate, dipentaerythritol hexaacrylate, or combinations thereof. The aforementioned polymerizable resin can be further mixed with acrylic resin with a reactive functionality of 1˜2, epoxy resin with a reactive functionality of 1˜2, or polyurethane with a reactive functionality of 1˜2, such as methyl acrylate, ethyl acrylate, butyl acrylate, 2-ethyl hexyl acrylate, 2-hydroxyl ethyl acrylate, 2-hydroxy propylacrylate, acrylamide, -methacryloxypropyl trimethoxy silane, 1,4-butanediol dimethacrylate, 1,6-hexanediol diacrylate, 1,6-hexanediol dimethacrylate, ethyleneglycol diacrylate, N,N′-dicyclohexyl carbodimide, N,N-Dimethylformamide, t-butyl 1,3-diperoxyacetate, t-butyl bperoxybenzoate, t-pentyl 1,2-diperoxybutyrate, t-butyl peroxymaleate, t-pentyl iso-peroxybutyrate, t-pentyl peroxyformylate, t-butyl peroxly-2-ethyl hexanone, phenyl peroxide, or combinations thereof.

The initiator can be a photo-initiator or a thermal initiator, such as peroxide or azo initiator, which generates, upon activation, free radical species through decomposition, and can be 2,2′-azobis(2-cyano-2-butane), dimethyl 2,2′-azobis(methyl isobutyrate), 4,4′-azobis(4-cyanopentanoic acid), 4,4′-azobis(4-cyanopentan-1-ol), 1,1′-azobis(cyclohexane carbonitrile), 2-(t-butylazo)-2-cyanopropane, 2,2′-azobis[2-methyl-(N)-(1,1)-bis(hydroxymethyl)-2-hydroxyethyl]propionamide, 2,2′-azobis[2-methyl-N-hydroxyethyl)]propionamide, 2,2!-azobis(N,N′-dimethyleneisobutyramidine)dihydrochloride, 2,2′-azobis(2-amidinopropane) dihydrochloride, 2,2′-azobis (N,N′-dimethyleneisobutyramine), 2,2′-azobis(2-methyl-N-[1,1-bis(hydroxymethyl)-2-hydroxyethyl]propionamide, 2,2′-azobis(2-methyl-N-[1,1-bis(hydroxymethyl)ethyl]propionamide), 2,2′-azobis[2-methyl-N-(2-hydroxyethyl)propionamide], 2,2′-azobis(isobutyramide)dihydrate, 2,2′-azobis(2,2,4-trimethylpentane), 2,2′-azobis(2-methylpropane), dilauroyl peroxide, tertiary amyl peroxides, tertiary amyl peroxydicarbonates, t-butyl peroxyacetate, t-butyl peroxybenzoate, t-butyl peroxyoctoate, t-butyl peroxyneodecanoate, t-butylperoxy isobutyrate, t-amyl peroxypivalate, t-butyl peroxypivalate, di-isopropyl peroxydicarbonate, dicyclohexyl peroxydicarbonate, dicumyl peroxide, dibenzoyl peroxide, potassium peroxydisulfate, ammonium peroxydisulfate, di-tert butyl peroxide, di-t-butyl hyponitrite, dicumyl hyponitrite or combinations thereof. The template comprises non-reactive organic compound, non-reactive oligomer, non-reactive polymer, or combinations thereof.

The first organic solvent must dissolve the polymerizable resin and template simultaneously. The first organic solvent can comprise tetrahydrofuran, acetone, methyl-ethyl ketone, methyl-isobutyl ketone, benzene, toluene, or combinations thereof. It should be noted that the second organic solvent must dissolve the template dispersed over the dry film and leave the obtained polymer of the polymerizable resin. The second organic solvent can comprise hexane, ethanol, ethyl acetate, or combinations thereof.

While the essential ingredients in the polymer composition according are the above described components, the inventive polymer composition can be optionally admixed with an additive, such as planarization reagent, leveling agent, tackifier, filler, defoamer, or mixtures thereof. In addition, the additive is preferably present in an amount of 0.5 to 50 parts by weight, based on 100 parts by weight of the polymerizable resin and the template.

As a main feature and a key aspect, the distribution and the volume ratio of the nanopores are controlled by modifying the viscosity of polymer composition, the rate of polymerization (depend on polymerizable resin functionality) and the weight ratio between the template and the polymerizable resin, in order to maintain the dispersion of the template over the dry film under polymerization of the resin rather than combination. As a result, polymer films having a sponge-like profile can be obtained. Particularly, the viscosity of the polymer composition has to be controlled within the range of 50˜18000 CPS/25° C., preferably of 3000˜8000 CPS/25° C. And, the weight ratio between the template and the polymerizable resin has to be controlled within the range of 1:20 to 1:2, preferably of 1:10 to 1:2.

The present invention is novel in that the phase separation is induced by polymerization of the polymerizable resin, rather than induced by mixture of two mutually incompatible polymers as disclosed in related art. In the process of fabricating the polymer film according to the invention, the template is generally enclosed by polymerized resin and dispersed uniformly over the dry film, with the increase of molecular weight of the polymerized resin. The template is subsequently dissolved out of the dry film by the second organic solvent to form the polymers film with nanopores dispersing uniformly thereover. A feature of the present invention is that the rate of polymerization, the compatibility and weight ratio between the template and the resin, and the viscosity of the polymer composition are designed within a particular range, resulting in uniform nanopore distribution and controllable nanopore volume ratio of the obtained film. Therefore, the polymer film of the invention can serve as an antireflection film due to the sponge-like profile thereof.

The following examples are intended to demonstrate this invention more fully without limiting its scope, since numerous modifications and variations will be apparent to those skilled in the art.

### EXAMPLE 1

8g (26.82 mmol) pentaerythritol triacrylate, as a polymerizable resin was put into a bottle and dissolved in 100 g tetrahydrofuran at 25° C. Then, 3.43 g nematic liquid crystal (sold and manufactured under the trade number of E7 by Merck Co., Ltd), as a template, was added into the bottle. After stirring, 0.24 g triphenyl triflate, as an initiator, was added into the above mixture, and a polymer composition (A) was prepared. Wherein, the weight ratio between the template and the polymerizable resin was 3/7, and the viscosity of the polymer composition (pentaerythritol triacrylate dissolved in tetrahydrofuran) was 520 CPS/25° C.

Next, the polymer composition was coated on a glass substrate by spin coating at a speed of 2500 rpm in 30 sec. Next, the above coating was baked at 600 C for 3 min and exposed to a UV ray, forming a dry film by polymerization of pentaerythritol triacrylate. Next, the dry film was immersed in n-hexane to dissolve and remove the template, and a polymer film (A) with nanopores was formed. The polymer film (A) has a thickness of 150 nm.

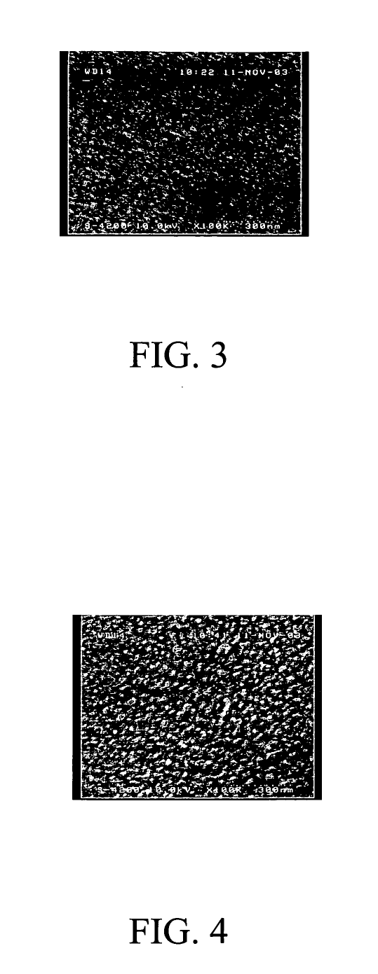

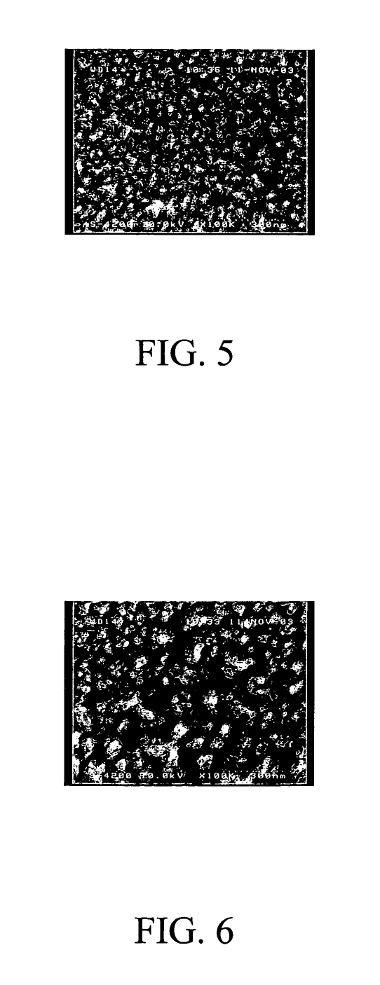

The polymer film (A) was identified by scanning electron microscopy (Model S-4200 mfd. by Hitachi, Ltd.) as shown in FIG. 3.

### EXAMPLE 2

Example 2 was performed as Example 1 except for substitution of 5.6 g pentaerythritol triacrylate and 2.4 g urethane acrylate for 8 g pentaerythritol triacrylate. Particularly, the weight ratio between pentaerythritol triacrylate and urethane acrylate was 7:3. The obtained polymer film (B) of Example 2 was identified by scanning electron microscopy as shown in FIG. 4.

### EXAMPLE 3

Example 3 was performed as Example 1 except for substitution of 4 g pentaerythritol triacrylate and 4 g urethane acrylate for 8 g pentaerythritol triacrylate. Particularly, the weight ratio between pentaerythritol triacrylate and urethane acrylate was 1:1. The obtained polymer film (C) of Example 3 was identified by scanning electron microscopy as shown in FIG. 5.

### EXAMPLE 4

Example 4 was performed as Example 1 except for substitution of 2.4 g pentaerythritol triacrylate and 5.6 g urethane acrylate for 8 g pentaerythritol triacrylate. Particularly, the weight ratio between pentaerythritol triacrylate and urethane acrylate was 3:7. The obtained polymer film (D) of Example 4 was identified by scanning electron microscopy as shown in FIG. 6.

### COMPARATIVE EXAMPLE 1

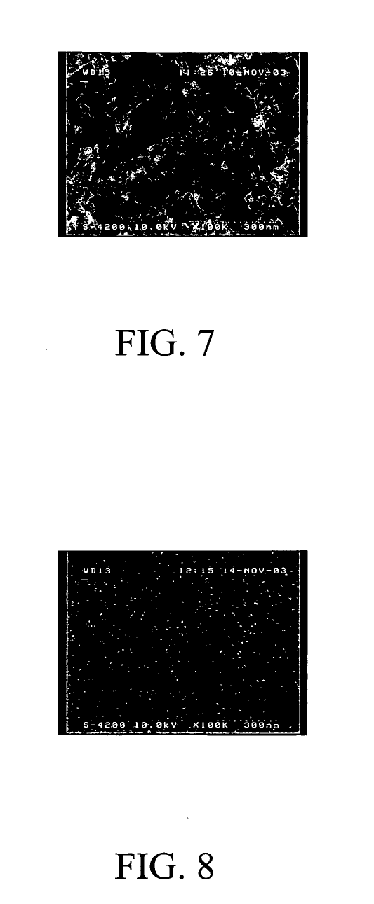

Comparative Example 1 was performed as Example 1 except for substitution of 8 g urethane acrylate for 8 g pentaerythritol triacrylate. The obtained polymer film of Comparative Example 1 was identified by scanning electron microscopy as shown in FIG. 7.

Table. 1 shows the weight ratio between pentaerythritol triacrylate (having a reactive functionality of 3) and urethane acrylate (having a reactive functionality of 2) of Examples 1˜4 and Comparative Example 1. Referring to FIGS. 3˜7, the polymer film, which is prepared form resin with higher reactive functionality, is more apt to present a sponge-like profile. As a main feature and a key aspect, the polymerizable resin of the invention has a reactive functionality more than 2, preferably more than 2.5, and more preferably more than 2.7. Since the polymerizable resin with higher reactive functionality can increase the polymerization rate thereof, the template is enclosed instantly by the obtained polymer and dispersed uniformly over the dry film, rather than combining together resulting from phase repulsion.

TABLE 1

| | pentaerythritol triacrylate/ |
|---|---|
| | urethane acrylate |
| Example 1 | 100/0 |
| Example 2 | 70/30 |
| Example 3 | 50/50 |
| Example 4 | 30/70 |
| Comparative | 0/100 |
| Example 1 | |

### EXAMPLE 5

Example 5 was performed as Example 2 except for substitution of 0.89 g nematic liquid crystal for 3.43 g nematic liquid crystal. Particularly, the weight ratio between template and polymerizable resin was 1/9. The obtained polymer film (e) of Example 5 was identified by scanning electron microscopy as shown in FIG. 8.

### EXAMPLE 6

Example 6 was performed as Example 2 except for substitution of 2.0 g nematic liquid crystal for 3.43 g nematic liquid crystal. Particularly, the weight ratio between template and polymerizable resin was 1/4. The obtained polymer film (f) of Example 6 was identified by scanning electron microscopy as shown in FIG. 9.

### COMPARATIVE EXAMPLE 2

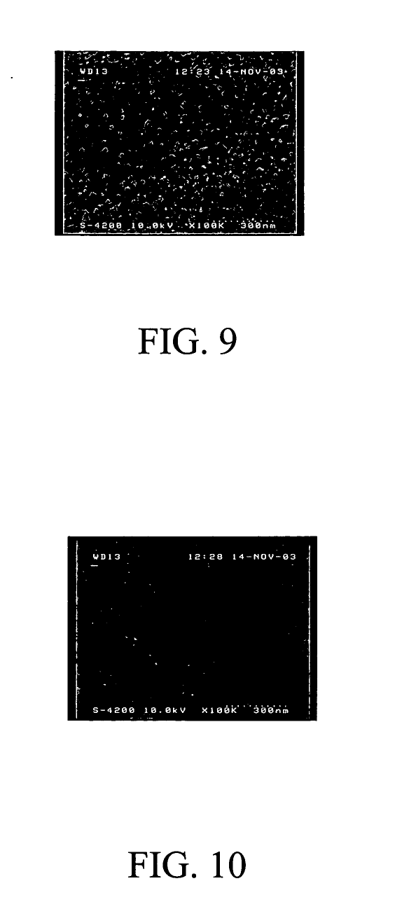

Comparative Example 2 was performed as Example 2 except for substitution of 5.34 g nematic liquid crystal for 3.43 g nematic liquid crystal. Particularly, the weight ratio between template and polymerizable resin was 2/3. The obtained polymer film of Comparative Example 2 was identified by scanning electron microscopy as shown in FIG. 10.

Table. 2 shows the weight ratio between template and polymerizable resin of Examples 2, 5˜6 and Comparative Example 2. Referring to FIGS. 4, and 8˜10, the polymer films have nanopores larger diameter when the weight ratio between template and polymerizable resin is increased. Accordingly, the weight ratio between template and polymerizable resin of the invention must be less than 1/2, in order to maintain nanopores with suitable diameters (20˜80 nm). Since the diameter of the nanopores is 20˜80 nm wide, the nanoporous polymer film exhibits a superior mechanical strength.

TABLE 2

| | Template (g)/ |
|---|---|
| | polymerizable resin (g) |
| Example 2 | 3/7 |
| Example 5 | 1/9 |
| Example 6 | 2/8 |
| Comparative | 4/6 |
| Example 1 | |

### EXAMPLE 7

9.8 g pentaerythritol triacrylate, 18.9 g tris(2-hydroxyethyl)isocyanurate triacrylate, 18.9 g propoxylated(6)trimethylolpropane tri-acrylat, and 18.9 g urethane acrylate oligomer were put into a bottle and dissolved in 900 g tetrahydrofuran at 25° C. Then, 3.5 g γ-methacryloxypropyltrimethoxysilane, as a tackifier, was added into the bottle. Next, 30 g nematic liquid crystal (sold and manufactured under the trade number of E7 by Merck Co., Ltd) was added into the bottle. After stirring completely, 3.5 g triphenyl triflate, as an initiator, was added into the above mixture, and a polymer composition was prepared. Wherein, the weight ratio between the template and the polymerizable resin was 3/7, and the viscosity of the polymer composition was 7300 CPS/25° C.

Next, the polymer composition was coated on a glass substrate by spin coating at a speed of 2500 rpm for 30 sec. Next, the above coating was baked at 60° C. for 3 min and exposed to a UV ray, forming a dry film by polymerization of the polymerizable resin. Next, the dry film was immersed in n-hexane to dissolve and remove the template, and a polymer film (g) with nanopores was formed. The polymer film (A) has a thickness (Tₐᵥ) of 120 nm.

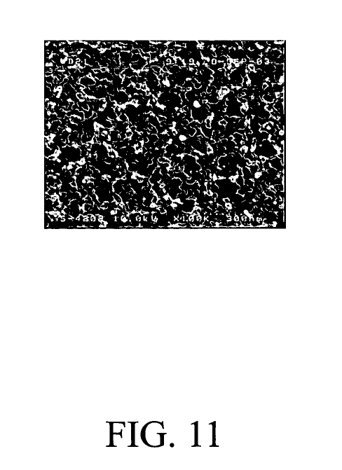

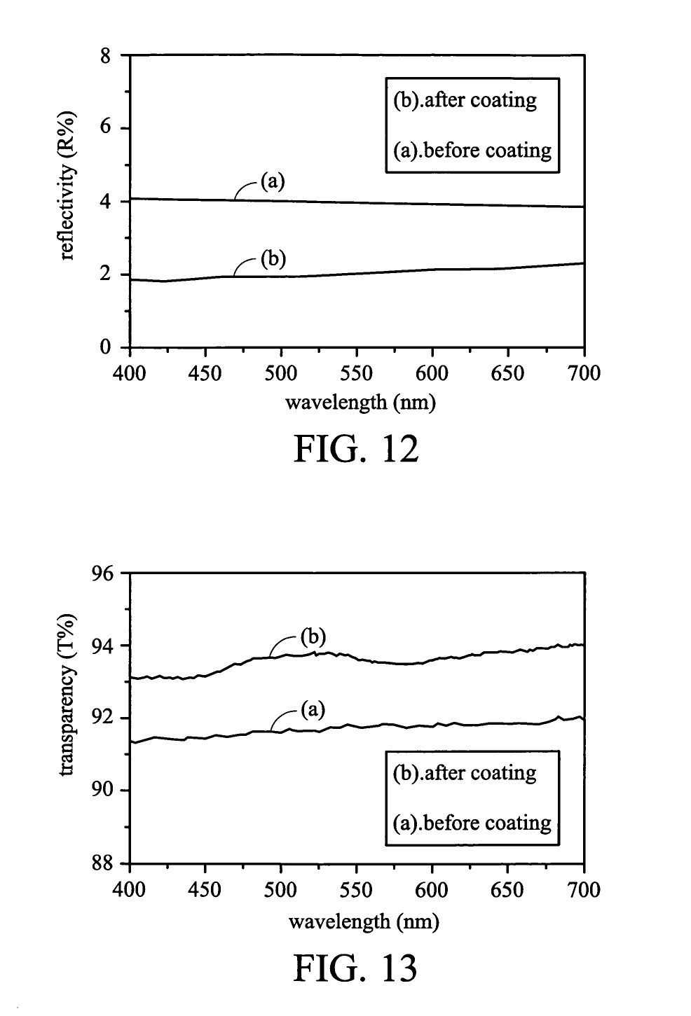

The polymer film (g) was identified by scanning electron microscopy (Model S-4200 mfd. by Hitachi, Ltd.) as shown in FIG. 11. Afterward, the polymer film (g) was detected to have reflectivity and transparency at a measuring wavelength of 400˜700 nm. Referring to FIGS. 12 and 13, the polymer film (g) has an average reflectivity of about 2% and an aveage transparency of about 93%. Moreover, since the contact angle of the polymer film (g) to water is 114°.

The polymer film with three-dimensional nanopores according to the invention has a plurality of nanopores distributed uniformly thereover and presents a sponge-like profile. Due to the nanopores being sufficiently filled by air, the polymer film has a refractive index of less than 1.45.

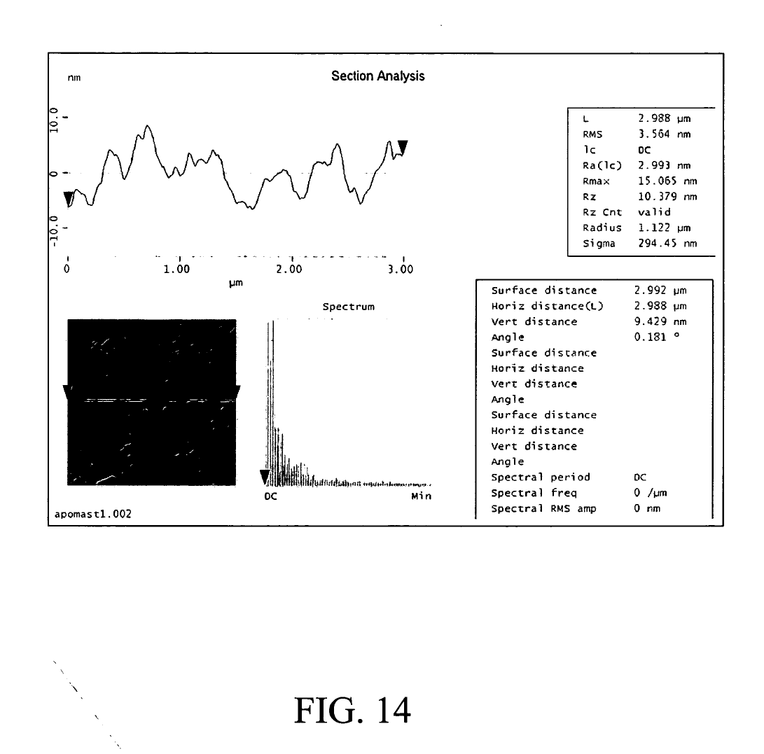

FIG. 14 was an atomic force microscope (AFM) photograph of the polymer film (g) in Example 7 of the invention. Referring to the section analysis of FIG. 14, the maximum peak-to-valley height (Rₘₐₓ) of the polymer film (g) was 15.06 nm, and the ratio between Rₘₐₓ and Tₐᵥ was about 1/8. The results prove that the polymer film with three-dimensional nanopores of the invention presents a sponge-like profile, rather than a wave-shaped profile which has a ratio between Rₘₐₓ and Tₐᵥ of about 1/1. Moreover, due to the reduced roughness, the polymer film exhibits superior antifouling properties in comparison with conventional nanoporous polymer film having wave-shaped profile.

While the invention has been described by way of example and in terms of preferred embodiment, it is to be understood that the invention is not limited thereto. It is therefore intended that the following claims be interpreted as covering all such alteration and modifications as fall within the true spirit and scope of the invention.

What is claimed is:

1. A method for fabricating polymer film with three-dimensional nanopores, comprising
(a) providing a substrate with a surface;
(b) forming a coating of a polymer composition on the surface, wherein the polymer composition comprises the following components as a uniform solution in a first organic solvent:
a polymerizable resin, having a reactive functionality of more than 2.0, in an amount of 45 to 95 parts by weight;
a template in an amount of 5 to 55 parts by weight; and
an initiator in an amount of 1 to 10 parts by weight, based on 100 parts by weight of the polymerizable resin and the template;
(c) curing the coating to form a dry film; and
(d) dissolving the template out of the dry film by a second organic solvent to leave a polymer film, with three-dimensional nanopores, having a sponge-like profile.

2. The method as claimed in claim 1, wherein the polymerizable resin comprises acrylic resin, epoxy resin, polyurethane or combinations thereof.

3. The method as claimed in claim 1, wherein the polymerizable resin has a reactive functionality of more than 2.5.

4. The method as claimed in claim 1, wherein the polymerizable resin comprises acrylic resin with a reactive functionality of 3˜9, epoxy resin with a reactive functionality of 3˜9, polyurethane with a reactive functionality of 3˜9, or combinations thereof.

5. The method as claimed in claim 4, wherein the polymerizable resin comprises triethyleneglycol diacrylate, tripropyleneglycol diacrylate, neopentylglycol diacrylate, trimethylolpropane triacrylate, trimethylolpropane trimethacrylate, triacylate of ethylene oxide modified trimethylolpropane pentaerythritol triacrylate, pentaerythritol tetraacrylate, ethoxylated pentaerythritol tetraacrylate, dipentaerythritol pentaacrylate, dipentaerythritol hexaacrylate, or combinations thereof.

6. The method as claimed in claim 4, wherein the polymerizable resin further comprises acrylic resin with a reactive functionality of 1˜2, epoxy resin with a reactive functionality of 1˜2, polyurethane with a reactive functionality of 1˜2, or combinations thereof.

7. The method as claimed in claim 6, wherein the acrylic resin, epoxy resin, and polyurethane with a reactive functionality of 1˜2 comprise methyl acrylate, ethyl acrylate, butyl acrylate, 2-ethyl hexyl acrylate, 2-hydroxyl ethyl acrylate, 2-hydroxy propylacrylate, acrylamide, -methacryloxypropyl trimethoxy silane, 1,4-butanediol dimethacrylate, 1,6-hexanediol diacrylate, 1,6-hexanediol dimethacrylate, ethyleneglycol diacrylate, N,N′-dicyclohexyl carbodimide, N,N-Dimethylformamide, t-butyl 1,3-diperoxyacetate, t-butyl bperoxybenzoate, t-pentyl 1,2-diperoxybutyrate, t-butyl peroxymaleate, t-pentyl iso-peroxybutyrate, t-pentyl peroxyformylate, t-butyl peroxly-2-ethyl hexanone, phenyl peroxide, or combinations thereof.

8. The method as claimed in claim 1, wherein the template comprises non-reactive organic compound, non-reactive oligomer, non-reactive polymer, or combinations thereof.

9. The method as claimed in claim 1, wherein the polymer composition has a viscosity of 50˜18000 CPS/25° C.

10. The method as claimed in claim 1, wherein the weight ratio between the template and the polymerizable resin is 1:20 to 1:2.

11. The method as claimed in claim 1, wherein the diameter of the nanopores is 20˜80 nm.

12. The method as claimed in claim 1, wherein the polymer composition further comprises an additive in an amount of 0.5 to 50 parts by weight, based on 100 parts by weight of the polymerizable resin and the template, wherein the additive comprises planarization reagent, leveling agent, tackifier, filler, defoamer, or combinations thereof.

13. The method as claimed in claim 1, wherein the substrate is a transparent substrate.

14. The method as claimed in claim 13, wherein the substrate is a glass substrate, plastic substrate, or ceramic substrate.

15. The method as claimed in claim 1, wherein the polymer composition is coated on the substrate by spin coating, dip coating, roll coating, printing, embossing, stamping, or spray coating.

16. The method as claimed in claim 1, wherein the coating is cured to form a dry film by heating or exposure to an actinic ray.

17. A polymer film, comprising the product through the following steps:
(a) forming a coating of a polymer composition on a substrate, wherein the polymer composition comprising the following components as a uniform solution in a first organic solvent:
a polymerizable resin, having a reactive functionality of more than 2.0, in an amount of 45 to 95 parts by weight;
a template in an amount of 5 to 55 parts by weight; and
an initiator in an amount of 1 to 10 parts by weight, based on 100 parts by weight of the polymerizable resin and the template;
(b) curing the coating to form a dry film; and
(c) dissolving the template out of the dry film by a second organic solvent to leave a polymer film, with three-dimensional nanopores, having a sponge-like profile, wherein the thickness of the polymer film is 50˜200 nm, and the diameter of the nanopores is 20˜80 nm.

18. The polymer film as claimed in claim 17, wherein the polymerizable resin comprises acrylic resin, epoxy resin, polyurethane or combinations thereof.

19. The polymer film as claimed in claim 17, wherein the polymerizable resin has a reactive functionality of more than 2.5.

20. The polymer film as claimed in claim 17, wherein the polymerizable resin comprises acrylic resin with a reactive functionality of 3˜9, epoxy resin with a reactive functionality of 3˜9, polyurethane with a reactive functionality of 3˜9, or combinations thereof.

21. The polymer film as claimed in claim 20, wherein the polymerizable resin comprises triethyleneglycol diacrylate, tripropyleneglycol diacrylate, neopentylglycol diacrylate, trimethylolpropane triacrylate, trimethylolpropane trimethacrylate, triacylate of ethylene oxide modified trimethylolpropane pentaerythritol triacrylate, pentaerythritol tetraacrylate, ethoxylated pentaerythritol tetraacrylate, dipentaerythritol pentaacrylate, dipentaerythritol hexaacrylate, or combinations thereof.

22. The polymer film as claimed in claim 20, wherein the polymerizable resin further comprises acrylic resin with a reactive functionality of 1˜2, epoxy resin with a reactive functionality of 1˜2, polyurethane with a reactive functionality of 1˜2, or combinations thereof.

23. The polymer film as claimed in claim 22, wherein the acrylic resin, epoxy resin, and polyurethane with a reactive functionality of 1˜2 comprise methyl acrylate, ethyl acrylate, butyl acrylate, 2-ethyl hexyl acrylate, 2-hydroxyl ethyl acrylate, 2-hydroxy propylacrylate, acrylamide, -methacryloxypropyl trimethoxy silane, 1,4-butanediol dimethacrylate, 1,6-hexanediol diacrylate, 1,6-hexanediol dimethacrylate, ethyleneglycol diacrylate, N,N′-dicyclohexyl carbodimide, N,N-Dimethylformamide, t-butyl 1,3-diperoxyacetate, t-butyl bperoxybenzoate, t-pentyl 1,2-diperoxybutyrate, t-butyl peroxymaleate, t-pentyl iso-peroxybutyrate, t-pentyl peroxyformylate, t-butyl peroxly-2-ethyl hexanone, phenyl peroxide, or combinations thereof.

24. The polymer film as claimed in claim 17, wherein the template comprises non-reactive organic compound, non-reactive oligomer, non-reactive polymer, or combinations thereof.

25. The polymer film as claimed in claim 17, wherein the polymer composition has a viscosity of 50˜18000 CPS/25° C.

26. The polymer film as claimed in claim 17, wherein the weight ratio between the template and the polymerizable resin is 1:20 to 1:2.

27. The polymer film as claimed in claim 17, wherein the polymer composition further comprises an additive in an amount of 0.5 to 50 parts by weight, based on 100 parts by weight of the polymerizable resin and the template, wherein the additive comprises planarization reagent, leveling agent, tackifier, filler, defoamer, or combinations thereof.

28. An antireflection film, comprising the product through the following steps:
(a) forming a coating of a polymer composition on a substrate, wherein the polymer composition comprising the following components as a uniform solution in a first organic solvent:
a polymerizable resin, having a reactive functionality of more than 2.0, in an amount of 45 to 95 parts by weight;
a template in an amount of 5 to 55 parts by weight; and
an initiator in an amount of 1 to 10 parts by weight, based on 100 parts by weight of the polymerizable resin and the template;
(b) curing the coating to form a dry film; and
(c) dissolving the template out of the dry film by a second organic solvent to leave an antireflection film having a sponge-like profile, wherein the antireflection film exhibits a reflectivity of less than 2.0%, a transparency of more than 93% and a haze of 0.1˜35%.

29. The antireflection film as claimed in claim 28, wherein the contact angle of the antireflection film to water is more than 90°.
